(19) United States
(12) Patent Application Publication
(10) Pub. No.: US 2026/0343125 A1
(43) Pub. Date: Oct. 29, 2026

(54) SPEAKER ASSEMBLY AND DISPLAY DEVICE INCLUDING THE SAME

(71) Applicant: LG ELECTRONICS INC., Seoul (KR)

(72) Inventor: Hyunseung YOUN, Seoul (KR)

(73) Assignee: LG ELECTRONICS INC., Seoul (KR)

(21) Appl. No.: 19/654,323

(22) Filed: Apr. 21, 2026

(30) Foreign Application Priority Data
Apr. 24, 2025 (KR) 10-2025-0054017

(51) Int. Cl. H04R 1/02; H04R 7/16; H04R 7/26

(52) U.S. Cl. CPC H04R 1/025; H04R 1/028; H04R 7/16; H04R 7/26; H04R 2201/02; H04R 2499/15

(57) ABSTRACT

A speaker assembly and a display device including the same are provided. The speaker assembly according to the present disclosure includes: a speaker unit configured to provide sound; and an enclosure to which the speaker unit is coupled, wherein the speaker unit includes: a speaker frame defining a space; a diaphragm blocking one side of the space and connected to the speaker frame; a bobbin disposed in the space of the speaker frame and connected to the diaphragm to vibrate the diaphragm; and a damper having one side fixed to the speaker frame and an opposite side supporting the bobbin, wherein the damper includes: a first damper frame fixed to one side of the speaker frame; a second damper frame disposed opposite the first damper frame with respect to the bobbin and fixed to an opposite side of the speaker frame; a bobbin hole into which the bobbin is inserted; and a vibrator connecting the bobbin hole and the damper frame and having a wave shape, wherein the vibrator has an edge which is cut from the first damper frame toward the second damper frame such that a wave-shaped cross section of the vibrator is exposed.

### CROSS-REFERENCE TO RELATED APPLICATION(S)

Pursuant to 35 U.S.C. § 119, this application claims the benefit of earlier filing date and right of priority to Korean Application No(s). 10-2025-0054017, filed on Apr. 24, 2025, the contents of which are all incorporated by reference herein in its entirety.

### BACKGROUND OF THE INVENTION

### 1. Field of the Invention

The following description relates to a speaker assembly and a display device including the same.

### 2. Description of the Related Art

With the development of the information society, there have been growing demands for various types of display devices, and in order to meet these demands, various display devices, such as a liquid crystal display (LCD), a plasma display panel (PDP), an electroluminescent display (ELD), a vacuum fluorescent display (VFD), an organic light emitting diode (OLED), etc., have been studied and used recently.

Among these devices, the LCD panel includes a TFT substrate and a color substrate which are positioned opposite each other with a liquid crystal layer interposed therebetween, and displays images by using light provided by a backlight unit. Further, the OLED panel may display images by using a self-luminous organic layer deposited on a substrate on which transparent electrodes are formed.

The display device may be equipped with a speaker. The speaker is a device that converts an electrical signal into sound waves to output sound. The speaker may be divided into a woofer, a midrange, a tweeter, a full-range, and the like according to frequency ranges.

Recently, a speaker in the display device decreases in thickness as the display device becomes slimmer. Even when the speaker becomes slimmer, there is a need to improve speaker performance by maintaining a constant sound pressure or improving sound pressure.

### SUMMARY OF THE INVENTION

It is an objective of the present disclosure to solve the above and other problems.

It is another objective of the present disclosure to provide a speaker capable of maintaining or increasing sound pressure while having reduced thickness.

It is yet another objective of the present disclosure to ensure structural rigidity of a damper of a speaker without affecting vibration of the damper of the speaker.

It is yet another objective of the present disclosure to provide a high sound pressure and high-power speaker by suppressing rolling of a damper of the speaker.

It is yet another objective of the present disclosure to provide a structure of a damper capable of improving speaker performance.

It is yet another objective of the present disclosure to provide a display device including a high-performance slim speaker.

In accordance with an aspect of the present disclosure, the above and other objectives can be accomplished by providing a display device including: a display panel; a frame to which the display panel is coupled; and a speaker assembly coupled to the frame, wherein the speaker assembly includes: a speaker unit configured to provide sound; and an enclosure to which the speaker unit is coupled, wherein the speaker unit includes: a speaker frame defining a space; a diaphragm blocking one side of the space and connected to the speaker frame; a bobbin disposed in the space of the speaker frame and connected to the diaphragm to vibrate the diaphragm; and a damper having one side fixed to the speaker frame and an opposite side supporting the bobbin, wherein the damper includes: a first damper frame fixed to one side of the speaker frame; a second damper frame disposed opposite the first damper frame with respect to the bobbin and fixed to an opposite side of the speaker frame; a bobbin hole into which the bobbin is inserted; and a vibrator connecting the bobbin hole and the damper frame and having a wave shape, wherein the vibrator has an edge which is cut from the first damper frame toward the second damper frame such that a wave-shaped cross section of the vibrator is exposed.

In accordance with another aspect of the present disclosure, the above and other objectives can be accomplished by providing a speaker assembly including: a speaker unit configured to provide sound; and an enclosure to which the speaker unit is coupled, wherein the speaker unit includes: a speaker frame defining a space; a diaphragm blocking one side of the space and connected to the speaker frame; a bobbin disposed in the space of the speaker frame and connected to the diaphragm to vibrate the diaphragm; and a damper having one side fixed to the speaker frame and an opposite side supporting the bobbin, wherein the damper includes: a first damper frame fixed to one side of the speaker frame; a second damper frame disposed opposite the first damper frame with respect to the bobbin and fixed to an opposite side of the speaker frame; a bobbin hole into which the bobbin is inserted; and a vibrator connecting the bobbin hole and the damper frame and having a wave shape, wherein the vibrator has an edge which is cut from the first damper frame toward the second damper frame such that a wave-shaped cross section of the vibrator is exposed.

### EFFECTS OF THE INVENTION

A speaker assembly and a display device including the same according to the present disclosure has the following effects.

According to at least one of the embodiments of the present disclosure, a speaker capable of maintaining or increasing sound pressure while having reduced thickness may be provided.

According to at least one of the embodiments of the present disclosure, structural rigidity of a damper of a speaker may be ensured without affecting vibration of the damper of the speaker.

According to at least one of the embodiments of the present disclosure, a high sound pressure and high-power speaker may be provided by suppressing rolling of a damper of the speaker.

According to at least one of the embodiments of the present disclosure, a structure of a damper capable of improving speaker performance may be provided.

According to at least one of the embodiments of the present disclosure, a display device including a high-performance slim speaker may be provided.

Further scope of applicability of the present disclosure will become apparent from the detailed description given hereinafter. However, it should be understood that the detailed description and specific examples, while indicating preferred embodiments of the present disclosure, are given by illustration only, since various changes and modifications within the spirit and scope of the present disclosure will become apparent to those skilled in the art from this detailed description.

### BRIEF DESCRIPTION OF THE DRAWINGS

FIGS. 1 to 24 are diagrams illustrating examples of a speaker assembly and a display device including the same according to embodiments of the present disclosure.

### DETAILED DESCRIPTION OF THE PREFERRED EMBODIMENTS

Description will now be given in detail according to exemplary embodiments disclosed herein, with reference to the accompanying drawings. For the sake of brief description with reference to the drawings, the same or equivalent components may be denoted by the same reference numbers, and description thereof will not be repeated.

In general, suffixes such as “module” and “unit” may be used to refer to elements or components. Use of such suffixes herein is merely intended to facilitate description of the specification, and the suffixes do not have any special meaning or function.

In addition, it will be noted that a detailed description of known arts will be omitted if it is determined that the detailed description of the known arts can obscure the embodiments of the present disclosure. Further, the accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are only used to distinguish one element from another.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

A singular representation may include a plural representation unless context clearly

### Indicates Otherwise.

In the present application, it should be understood that the terms “comprises, includes,” “has,” etc. specify the presence of features, numbers, steps, operations, elements, components, or combinations thereof described in the specification, but do not preclude the presence or addition of one or more other features, numbers, steps, operations, elements, components, or combinations thereof.

References to directions, such as up (U), down (D), left (Le), right (Ri), front (F), and rear (R), shown in the drawings are provided merely for convenience of explanation and are not intended for limiting the scope of the present disclosure.

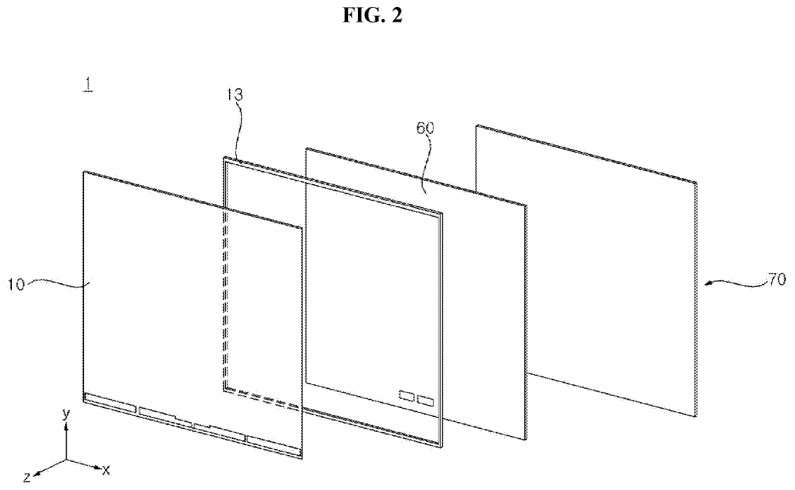

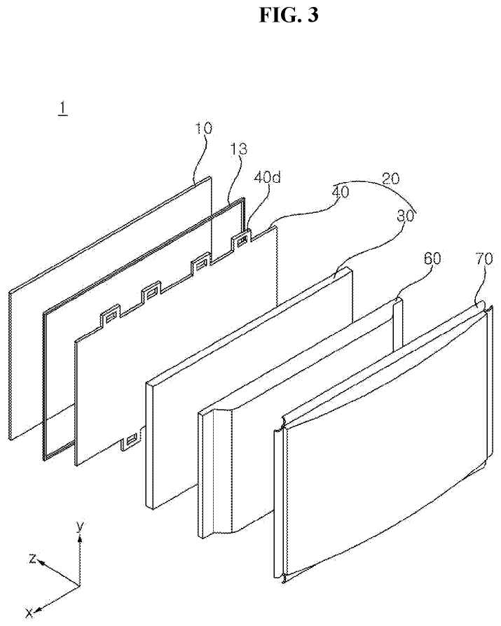

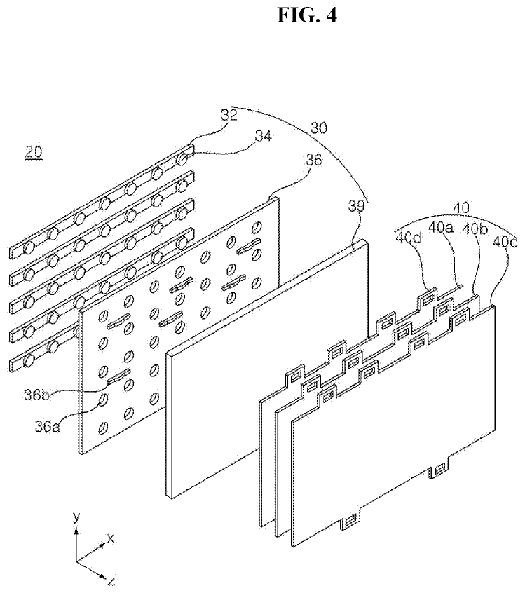

In the following description, a display panel of the present disclosure may be an OLED panel which will be described below with reference to FIG. 2, or an LCD panel which will be described below with reference to FIGS. 3 and 4, but the present disclosure may also be applied to various types of display devices other than these panels.

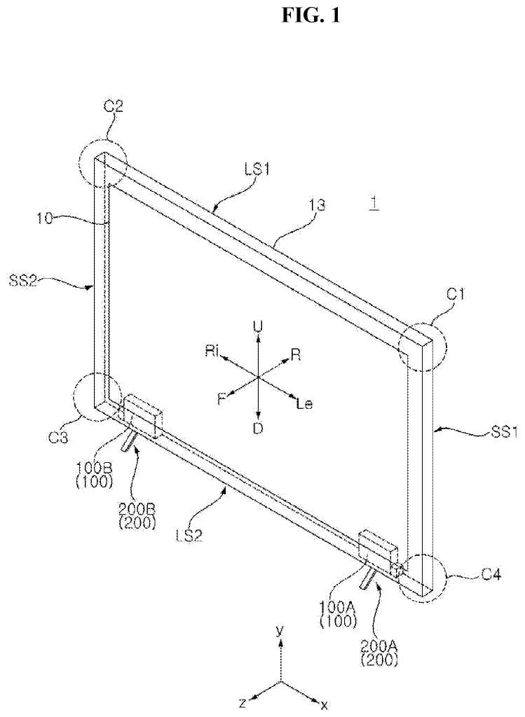

Referring to FIG. 1, a display device 1 includes a display panel 10. The display

### Panel 10 May Display an Image.

The display device 1 includes a first long side LS1, a second long side LS2 opposite to the first long side LS1, a first short side SS1 adjacent to the first long side LS1 and the second long side LS2, and a second short side SS2 opposite to the first short side SS1. For convenience of explanation, it is illustrated and described that lengths of the first and second long sides LS1 and LS2 are longer than lengths of the first and second short sides SS1 and SS2, but it is also possible that the lengths of the first and second long sides LS1 and LS2 are approximately equal to the lengths of the first and second short sides SS1 and SS2.

A direction parallel to the long sides LS1 and LS2 of the display device 1 may be referred to as a left-right direction. A direction parallel to the short sides SS1 and SS2 of the display device 1 may be referred to as an up-down direction. A direction perpendicular to the long sides LS1 and LS2 and the short sides SS1 and SS2 of the display device 1 may be referred to as a front-rear direction.

A side on which the display panel 10 displays an image may be referred to as a front side (F, z), and a side opposite thereto may be referred to as a rear side (R). The first long side LS1 may be referred to as an upper side (U, y), and the second long side LS2 may be referred to as a lower side (D). The first short side SS1 may be referred to as a left side (Le, x), and the second short side SS2 may be referred to as a right side (Ri).

The first long side LS1, the second long side LS2, the first short side SS1, and the second short side SS2 may be referred to as edges of the display device 1. A side frame 13 (see FIGS. 2 and 3) which will be described later may define the edges of the display device 1. Positions where the first long side LS1, the second long side LS2, the first short side SS1, and the second short side SS2 meet each other may be referred to as corners. A position where the first short side SS1 and the first long side LS1 meet may be referred to as a first corner C1. A position where the first long side LS1 and the second short side SS2 meet may be referred to as a second corner C2. A position where the second short side SS2 and the second long side LS2 meet may be referred to as a third corner C3. A position where the second long side LS2 and the first short side SS1 meet may

### Be Referred to As a Fourth Corner C4.

Referring to FIG. 2, the display device 1 may include a display panel 10, a side frame 13, a frame 60, and a back cover 70.

The display panel 10 may define a front surface of the display device 1 and display an image. The display panel 10 may divide an image into a plurality of pixels and may output the image while controlling color, brightness, and chroma or saturation of the respective pixels. The display panel 10 may be divided into an active area in which an image is displayed, and a de-active area in which no image is displayed. The display panel 11 may generate light corresponding to red, green, or blue color in response to a control signal.

The side frame 13 may extend along the edges of the display panel 10. The side frame 13 may be referred to as a guide panel 13 or a middle cabinet 13.

The frame 60 may be disposed at the rear of the display panel 10 and coupled to the display panel 10. The side frame 13 may be disposed between the display panel 10 and the frame 60 and coupled to the display panel 10 and the frame 60. Electronic components may be mounted to the frame 60. For example, the frame 60 may include a metal material, such as an aluminum alloy and the like. The frame 60 may be referred to as a main frame 60, a module cover 60, or a bottom cover 60.

The back cover 70 may cover the rear of the frame 60. The back cover 70 may be coupled to the frame 60. For example, the back cover 70 may be injection-molded from resin. In another example, the back cover 70 may include a metal material.

Referring to FIG. 3, the display device 1 may include a display panel 10, a side frame 13, a backlight unit 20, a frame 60, and a back cover 70.

The display panel 10 may define a front surface of the display device 1 and display an image. The display panel 10 may display an image in such a manner that each of a plurality of pixels outputs red, green, or blue (RGB) light in accordance with timing. The display panel 10 may be divided into an active area, in which the image is displayed, and a de-active area in which no image is displayed. The display panel 10 may include a front substrate and a rear substrate that are opposite each other with a liquid crystal layer interposed therebetween. The display panel 10 may be referred to as an LCD panel.

The front substrate may include a plurality of pixels, each of which consists of red, green, and blue subpixels. The front substrate may output light corresponding to red, green, or blue color in response to a control signal.

The rear substrate may include switching elements. The rear substrate may switch on or off pixel electrodes. For example, the pixel electrode may change a molecular arrangement of a liquid crystal layer in response to a control signal received from the outside. The liquid crystal layer may include liquid crystal molecules. The arrangement of the liquid crystal molecules may be changed depending on a voltage difference between the pixel electrode and a common electrode. The liquid crystal layer may transmit light, provided from the backlight unit 20, to the front substrate or may block the light.

The side frame 13 may extend along the edges of the display panel 10. The side frame 13 may be referred to as a middle cabinet 13 or a side frame 13.

The backlight unit 20 may be disposed at the rear of the display panel 10. The backlight unit 20 may include light sources. The backlight unit 20 may be coupled to a front surface of the frame 60. The backlight unit 20 may be driven by a full driving scheme or a partial driving scheme such as local dimming, impulsive driving, or the like. The backlight unit 20 may include an optical sheet 40 and an optical layer 30.

The optical sheet 40 may allow light of the light source to be evenly transmitted to the display panel 10. The optical sheet 40 may be composed of a plurality of layers. For example, the optical sheet 40 may include a prism sheet or a diffuser sheet, etc.

The frame 60 may be disposed at the rear of the display panel 10 and coupled to the display panel 10. The side frame 13 may be disposed between the display panel 10 and the frame 60 and coupled to the display panel 10 and the frame 60. Electronic components may be mounted to the frame 60. For example, the frame 60 may include a metal material, such as an aluminum alloy and the like. The frame 60 may be referred to as a main frame 60, a module cover 60, or a bottom cover 60.

The back cover 70 may cover the rear of the frame 60. The back cover 70 may be coupled to the frame 60. For example, the back cover 70 may be injection-molded from resin. In another example, the back cover 70 may include a metal material.

Referring to FIGS. 3 and 4, a backlight unit 20 may include an optical layer 30 and an optical sheet 40. The optical layer 30 may include a substrate 32, at least one light source 34, a reflective sheet 36, and a diffuser plate 39.

The substrate 32 may be coupled to the front surface of the frame 60. The substrate 32 may have a plate shape or include a plurality of straps that are vertically spaced apart from each other. The substrate 32 may be made of at least one of polyethylene terephthalate (PET), glass, polycarbonate (PC), and silicon. The substrate 32 may be a printed circuit board (PCB).

At least one light source 34 may be mounted on the substrate 32. A plurality of light sources 34 may be spaced apart from each other on the substrate 32. An electrode pattern for connecting an adapter and the light source 34 may be formed on the substrate 32. For example, a carbon nanotube (CNT) electrode pattern for connecting an adapter and the light source 34 may be formed on the substrate 32.

For example, the light source 34 may be a light emitting diode (LED) chip or an LED package including at least one LED chip. The light source 34 may be composed of a white LED or a colored LED that emits at least one color among colors such as red, green, blue, and the like. The colored LED may include at least one of a red LED, a green LED, or a blue LED. The light source 34 may be referred to as a light assembly 34.

The reflective sheet 36 may be disposed at the front of the substrate 32. The reflective sheet 36 may be disposed on the substrate 32 in a region other than a region where the light source 34 is formed. The reflective sheet 36 may have a hole 36a in which the light source 34 is disposed.

Further, the reflective sheet 36 may include, as a reflective material, at least one of a metal and a metal oxide. For example, the reflective sheet 36 may include a highly reflective metal, such as at least one of aluminum (Al), silver (Ag), gold (Au), or titanium dioxide (TiO2), and/or a metal oxide. For example, the resin may be deposited or applied on the light source 34 and/or the reflective sheet 36. The resin may serve to diffuse light of the light source 34. Accordingly, the reflective sheet 36 may reflect the light from the light source 34 or the light reflected from the diffuser plate 39 in a forward direction.

The diffuser plate 39 may be disposed at the front of the reflective sheet 36. The diffuser plate 39 may diffuse light of the light source 34. A spacer 36b may be disposed between the reflective sheet 36 and the diffuser plate 39 and may support a rear surface of the diffuser plate 39. Accordingly, an air gap may be formed between the reflective sheet 36 and the diffuser plate 39, and the light from the light source 34 may be spread widely by the air gap.

The optical sheet 40 may be disposed at the front of the diffuser plate 39. A rear surface of the optical sheet 40 may be in close contact with the diffuser plate 39, and a front surface of the optical sheet 40 may be in close contact with or adjacent to a rear surface of the display panel 10. The optical sheet 40 may include a prism sheet and/or a diffuser sheet.

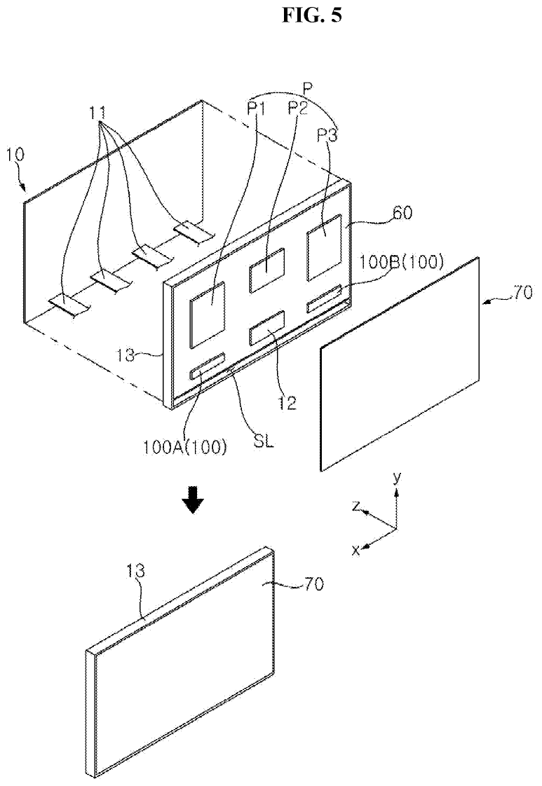

Referring to FIG. 5, a board P may be coupled to the frame 60. The board P may be disposed between the frame 60 and the back cover 70 and coupled to the rear surface of the frame 60. A plurality of electronic elements may be mounted on the board P. The board P may be a printed circuit board (PCB) and may be electrically connected to electronic components of the display device.

A power supply board P1 may supply power to each component of the display device. A main board P3 may control each component of the display device. A timing controller board P2 may be connected to the main board P3 through a cable and may provide an image signal to the display panel 10.

A cable 11 may be adjacent to the lower side of the display panel 10 and may be electrically connected to the display panel 10. The cable 11 may pass through a slit SL or hole formed in the frame 60. A source PCB 12 may be adjacent to the lower side of the frame 60 and coupled to the rear surface of the frame 60, and may be electrically connected to the cable 11. The source PCB 12 may be electrically connected to the timing controller board P2 through the cable.

Accordingly, the timing controller board P2 may provide digital video data and timing control signal to the display panel 10 via the source PCB 12.

Referring together to FIG. 1, a speaker 100 may be coupled to the frame 60. The speaker 100 may be disposed between the frame 60 and the back cover 70 and coupled to the rear surface of the frame 60. The speaker 100 may be adjacent to one side of the frame 60. The speaker 100 may be adjacent to the lower side of the frame 60 and may provide sound to the outside of the display device 1. For example, a plurality of speakers 100A and 100B may be coupled to the frame 60.

A sound device may include a speaker 100, a frame 60, and a component (holder which will be described later) for coupling the speaker 100 to the frame 60. The frame 60 may be the frame 60 of the display device described above. Alternatively, the frame 60 may be a frame of an audio device.

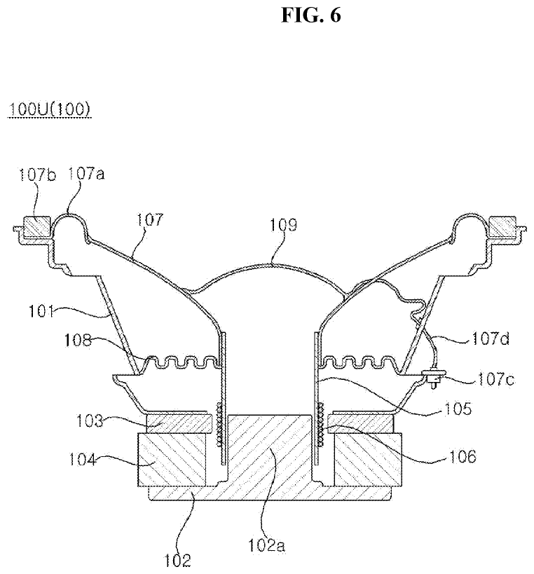

Referring to FIG. 6, a speaker frame 101 may support components of a speaker unit 100U of the speaker 100. The speaker 100 may be referred to as a speaker assembly 100 or a speaker module 100.

A first plate 102 may define one side of the speaker unit 100U. A pole piece 102a may protrude from a central portion of the first plate 102 and may have a hollow cylindrical shape or a solid cylindrical shape. A second plate 103 may be spaced apart from the first plate 102 and may have a ring shape. A portion of the pole piece 102a may pass through the second plate 103, and an air gap may be formed between the second plate 103 and the pole piece 102a.

A magnet 104 may be disposed between the first plate 102 and the second plate 103 and may have a ring shape. A portion of the pole piece 102a may pass through the magnet 104. A bobbin 105 may be disposed in an air gap between the pole piece 102a and the second plate 103 and an air gap between the pole piece 102a and the magnet 104, and may have a hollow cylindrical shape that extends in a longitudinal direction of the pole piece 102a. A coil 106 may be formed on or wound around an outer circumferential surface of the bobbin 105 and may be referred to as a voice coil 106. A terminal 107c and a tinsel wire 107d may deliver electrical energy, output from an amplifier, to the coil 106.

A spider 108 may have elasticity. The spider 108 may be disposed between the bobbin 105 and the speaker frame 101 and coupled to the bobbin 105 and the speaker frame 101. The spider 108 may support the bobbin 105 and may be referred to as a damper 108

One side of a diaphragm 107 may be coupled or attached to the bobbin 105, and an opposite side of the diaphragm 107 may be supported by an elastic edge 107a. For example, the diaphragm 107 may have a cone or dome shape. A gasket 107b may be provided on a lateral surface of the edge 107a and may prevent the interference of a surrounding mechanism with the vibrating diaphragm 107. For example, a dust cap 109 may cover the central portion of the diaphragm 107 and may block the inflow of dust and the like into a magnetic circuit.

When a magnetic line of force is formed in the air gap by the magnet 104 and current flows through the coil 106, Lorentz force may be generated. The magnitude of Lorentz force is proportional to the magnitude of the magnetic line of force (magnetic flux density), the amount of electric current, and the length of the wound coil, and the direction of the force may be perpendicular to the plane formed by the magnetic flux density and the current.

Accordingly, the diaphragm 107 may vibrate in the longitudinal direction of the pole piece 102a. When the diaphragm 107 moves upward, positive (+) sound pressure may be generated, and when the diaphragm 107 moves downward, negative (−) sound pressure may be generated, thereby allowing the speaker 100 to provide sound upward.

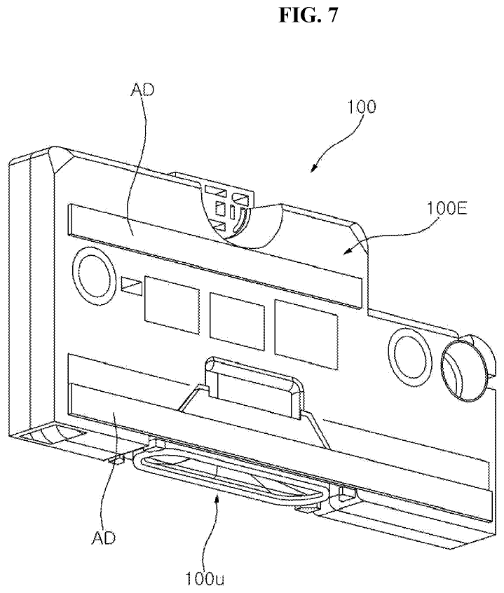

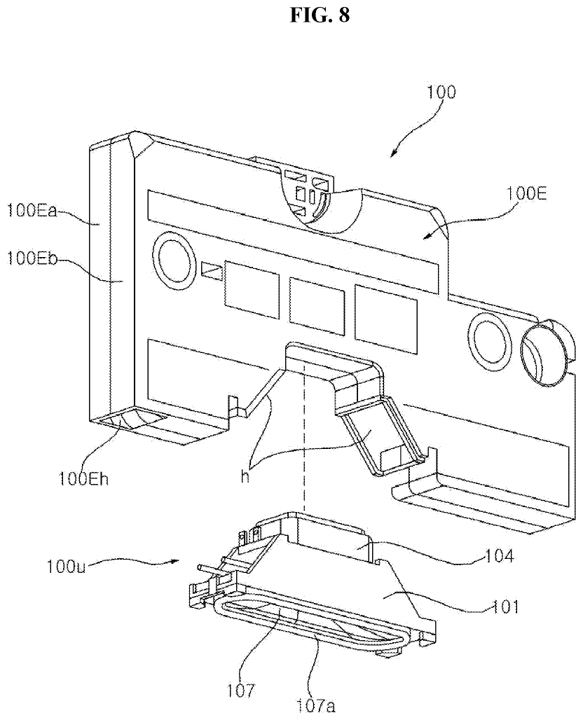

Referring to FIGS. 7 and 8, the speaker assembly 100 may include a speaker unit 100U and an enclosure 100E. The enclosure 100E may include a first case 100Ea and a second case 100Eb. The first case 100Ea may be coupled to the second case 100Eb. The enclosure 100E may have an inner space formed therein. The enclosure 100E may include an inlet h and an outlet 100Eh. The inlet h may communicate with the outlet 100Eh. The inlet h and the outlet 100Eh of the enclosure 100E may be connected by the inner space of the enclosure 100E. Sound entering through the inlet h may be output through the outlet 100Eh.

The speaker unit 100U may be coupled or fixed to one side of the enclosure 100E. The inlet h of the enclosure 100E may face the one side of the speaker unit 100U. For example, the inlet h of the enclosure 100E may be formed behind the speaker unit 100U. Sound generated from the speaker unit 100U may enter through the inlet h and may output to the outlet 100Eh through the inner space of the enclosure 100E. A direction facing the outlet 100Eh may be a direction facing the diaphragm 107 of the speaker unit 100U.

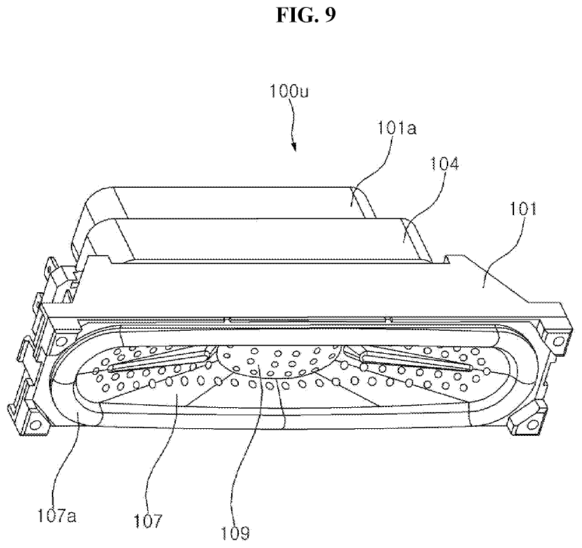

Referring to FIG. 9, the speaker frame 101 may be disposed opposite a speaker mount 101a with respect to the magnet 104. The speaker mount 101a may define one side of the speaker unit 100i.

The magnet 104 may be disposed between the speaker mount 101a and the speaker frame 101 and may have a rectangular shape. The diaphragm 107 may be coupled or fixed to the speaker frame 101 by the elastic edge 107a. For example, the diaphragm 107 may have a cone or dome shape having a major axis and a minor axis.

A dust cap 109 may cover a central portion of the diaphragm 107. The diaphragm 107 may vibrate. Sound pressure may be generated when the diaphragm 107 vibrates. The speaker unit 100U may provide sound by the sound pressure.

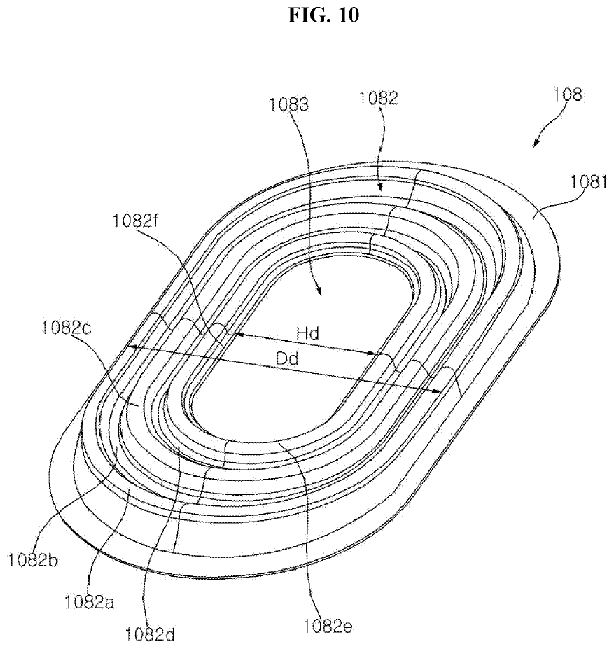

Referring to FIG. 10, the damper 108 may include a damper frame 1081, a bobbin hole 1083, and/or a vibrator 1082. The damper frame 1081 may have a track shape having a major axis and a minor axis. The damper frame 1081 may be a closed loop and may have a plate shape. A bobbin hole 1083 may have a shape corresponding to the damper frame 1081. The bobbin hole 1083 may be formed inside the damper frame 1081. The bobbin hole 1083 may have a track shape or an oval shape having a major axis and a minor axis.

The vibrator 1082 may be disposed between the damper frame 1081 and the bobbin hole 1083. The bobbin hole 1083 may be defined by the vibrator 1082. The vibrator 1082 may have a plurality of wrinkles. For example, the vibrator 1082 may have a plurality of crests 1082a, 1082c, and 1082e and a plurality of roots 1082b, 1082d, and 1082f between the bobbin hole 1083 and the damper frame 1081.

The vibrator 1082 may include the plurality of crests 1082a, 1082c, and 1082e and the plurality of roots 1082b, 1082d, and 1082f. The plurality of crests 1082a, 1082c, and 1082e may include a first crest 1082a, a second crest 1082c, and/or a third crest 1082e. The plurality of roots 1082b, 1082d, and 1082f may include a first root 1082b, a second root 1082d, and/or a third root 1082f. Each of the plurality of roots 1082b, 1082d, and 1082f may be disposed between the plurality of crests 1082a, 1082c, and 1082e. The first crest 1082a may be connected to an inner diameter of the damper frame 1081. The first root 1082b may be connected to an inner diameter of the first crest 1082a. The second crest 1082c may be connected to an inner diameter of the first root 1082b. The second root 1082d may be connected to an inner diameter of the second crest 1082c. The third crest 1082e may be connected to an inner diameter of the second root 1082d. The third root 1082f may be connected to an inner diameter of the third crest 1082e. An inner diameter of the third root 1082f may define the bobbin hole 1083.

Accordingly, the damper 108 may move by vibrating the bobbin hole 1083 in a thickness direction of the damper 108 based on the damper frame 1081.

A minor axis length Hd of the bobbin hole 1083 may be smaller than a minor axis length Dd of the damper 108. This means that when the minor axis length Dd of the damper 108 decreases, the minor axis length of the bobbin hole 1083 also decreases. That is, this means that when the speaker unit 100U (see FIG. 9) becomes slimmer, the sound pressure provided by the speaker unit 100U may decrease.

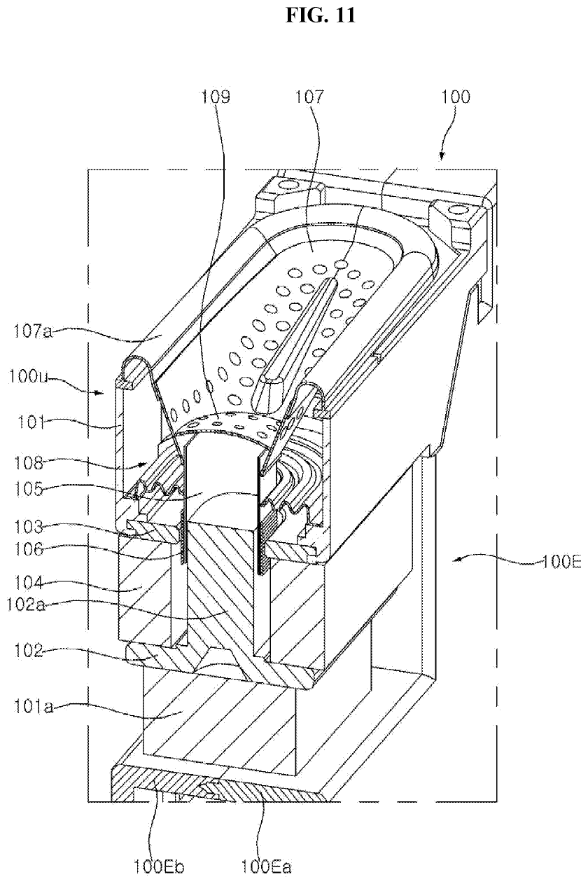

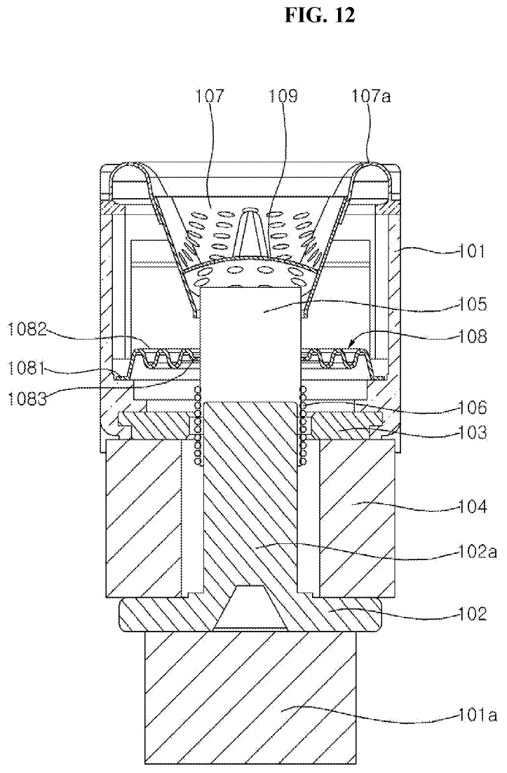

Referring to FIGS. 11 and 12, the first plate 102 may be coupled to the speaker mount 101a. The first plate 102 may be disposed opposite the enclosure 100E with respect to the speaker mount 101a. The pole piece 102a may protrude from a central portion of the first plate 102 and may have a hollow cylindrical shape or a solid cylindrical shape. The pole piece 102a may have a track-shaped or elliptical cross section. The second plate 103 may be spaced apart from the first plate 102 and may have a track shape or an elliptical shape. A portion of the pole piece 102a may pass through the second plate 103, and an air gap may be formed between the second plate 103 and the pole piece 102a.

The magnet 104 may be disposed between the first plate 102 and the second plate 103 and may have a track shape or an elliptical shape. A portion of the pole piece 102a may pass through the magnet 104. A bobbin 105 may be disposed in an air gap between the pole piece 102a and the second plate 103 and an air gap between the pole piece 102a and the magnet 104, and may have a hollow cylindrical shape that extends in a longitudinal direction of the pole piece 102a. The bobbin 105 may have a track-shaped or elliptical cross section.

The coil 106 may be formed on or wound around an outer circumferential surface of the bobbin 105 and may be referred to as a voice coil 106.

The damper 108 may have elasticity. The damper 108 may be disposed between the bobbin 105 and the speaker frame 101. The damper 108 may be coupled to the bobbin 105 and the speaker frame 101. The damper 108 may support the bobbin 105. The damper frame 1081 may be fixed to the inside of the speaker frame 101. For example, the bobbin 105 may be inserted into the bobbin hole 1083 of the damper 108 and supported by the vibrator 1082. In another example, the bobbin 105 may be inserted or press-fit into the bobbin hole 1083 of the damper 108. In another example, the bobbin hole 1083 may be bonded to an outer surface of the bobbin 105 to be fixed thereto. Accordingly, the damper 108 may suppress rolling of the bobbin 105.

One side of the diaphragm 107 may be coupled or attached to the bobbin 105, and an opposite side of the diaphragm 107 may be supported by an elastic edge 107a. The diaphragm 107 may generate sound by vibrating in the longitudinal direction of the pole piece 102a.

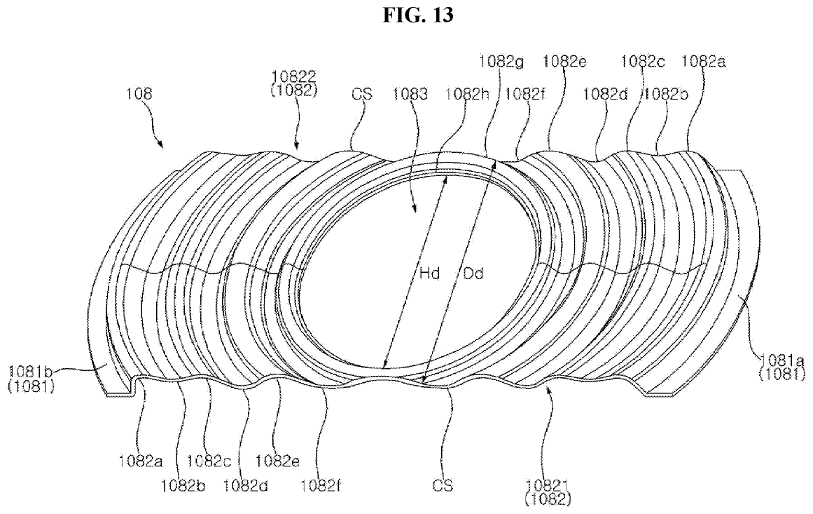

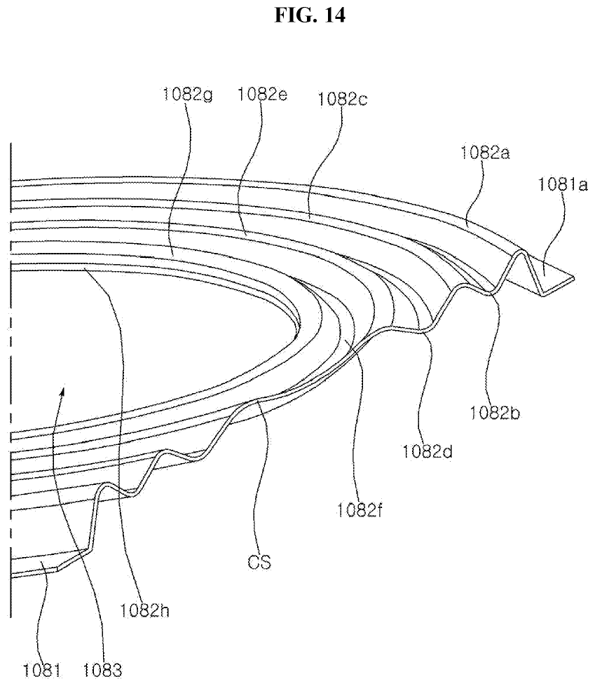

Referring to FIGS. 13 and 14, the damper 108 may include a damper frame 1081, a bobbin hole 1083, and/or a vibrator 1082. A plurality of damper frames 1081 may be provided. The damper frame 1081 may define both sides of the damper 108. For example, the damper frame 1081 may be an arc-shaped plate. A first damper frame 1081a may be disposed opposite a second damper frame 1081b with respect to the bobbin hole 1083.

The bobbin hole 1083 may be formed at the center of the first damper frame 1081a and the second damper frame 1081b. The bobbin hole 1083 may have a circular shape.

A plurality of vibrators 1082 may be provided. A first vibrator 10821 may be disposed between the first damper frame 1081a and the bobbin hole 1083. A second vibrator 10822 may be disposed between the second damper frame 1081b and the bobbin hole 1083.

The bobbin hole 1083 may be defined by the vibrator 1082. The vibrator 1082 may have a plurality of pleats or corrugations. For example, the vibrator 1082 may have a plurality of crests 1082a, 1082c, 1082e, and 1082g and a plurality of roots 1082b, 1082d, 1082f, and 1082h between the bobbin hole 1083 and the damper frame 1081.

The vibrator 1082 may include the plurality of crests 1082a, 1082c, 1082e, and 1082g and the plurality of roots 1082b, 1082d, 1082f, and 1082h. The plurality of crests 1082a, 1082c, 1082e, and 1082g may include a first crest 1082a, a second crest 1082c, a third crest 1082e, and a fourth crest 1082g. The plurality of roots 1082b, 1082d, 1082f, and 1082h may include a first root 1082b, a second root 1082d, a third root 1082f, and/or a fourth root 1082h. Each of the roots 1082b, 1082d, 1082f, and 1082h may be disposed between the plurality of crests 1082a, 1082c, 1082e, and 1082g to form a wave.

The first crest 1082a may be connected to an inner diameter of the damper frame 1081. The first root 1082b may be connected to an inner diameter of the first crest 1082a. The second crest 1082c may be connected to an inner diameter of the first root 1082b. The second root 1082d may be connected to an inner diameter of the second crest 1082c. The third crest 1082e may be connected to an inner diameter of the second root 1082d. The third root 1082f may be connected to an inner diameter of the third crest 1082e. The fourth crest 1082g may be connected to an inner diameter of the third root 1082f. The fourth root 1082h may be connected to an inner diameter of the fourth crest 1082g. An inner diameter of the fourth root 1082h may define the bobbin hole 1083.

The damper 108, including the bobbin hole 1083, the vibrator 1082, and/or the damper frame 1081, may be in the form of a generally ring-shaped circular plate with both sides being partially cut off. The damper 108 may include a cutting side or a cutting edge formed at the damper frame 1081 and/or the vibrator 1082. For example, a cutting side CS may form a wave in a linear direction. The damper 108 may move by vibrating the bobbin hole 1083 in a thickness direction of the damper 108 based on the damper frame 1081.

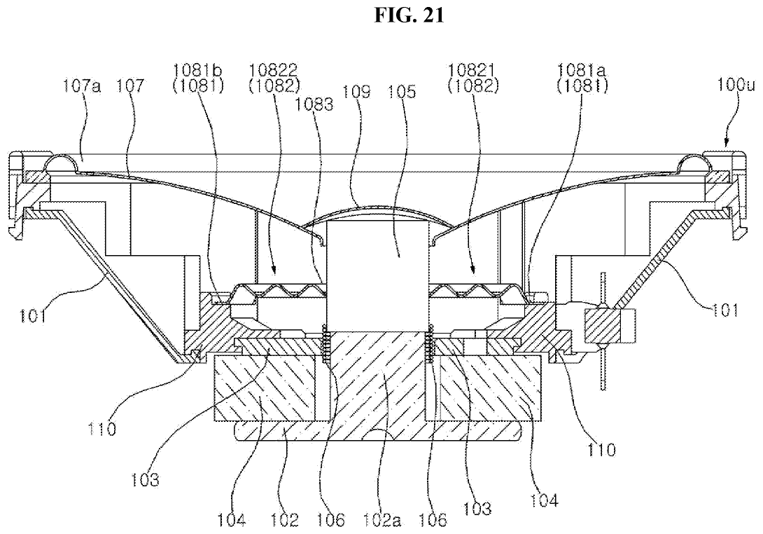

A diameter Hd of the bobbin hole 1083 may be smaller than a distance Dd between the cutting sides CS of the damper 108. In this case, the diameter Hd of the bobbin hole 1083 may be close to the distance Dd between the cutting sides CS of the damper 108. That is, this means that the distance Dd between the cutting sides CS of the damper 108 may be minimized, and the diameter of the bobbin 105 (see FIG. 21) may be maximized.

As the bobbin 105 (see FIG. 21) inserted into the bobbin hole 1083 is formed in a circular shape, the intensity of sound pressure generated by the bobbin 105 and the diaphragm 107 may increase. At the same time, the width of the damper 108 is reduced, thereby allowing the speaker unit 100U (see FIG. 9) to become slimmer.

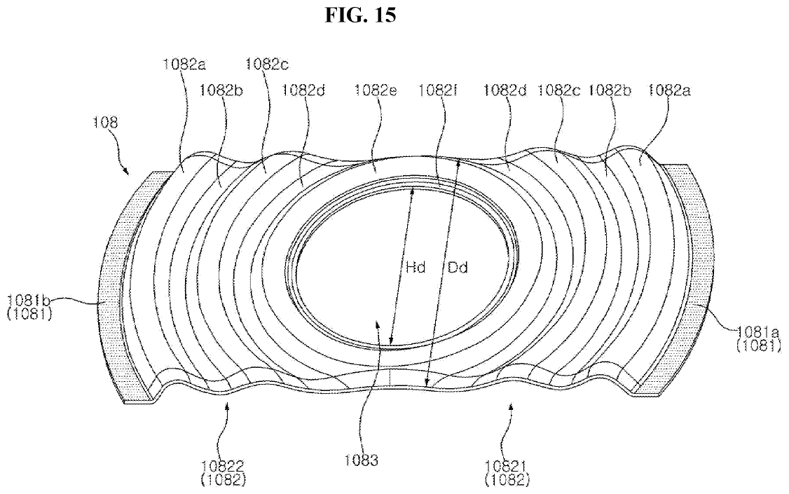

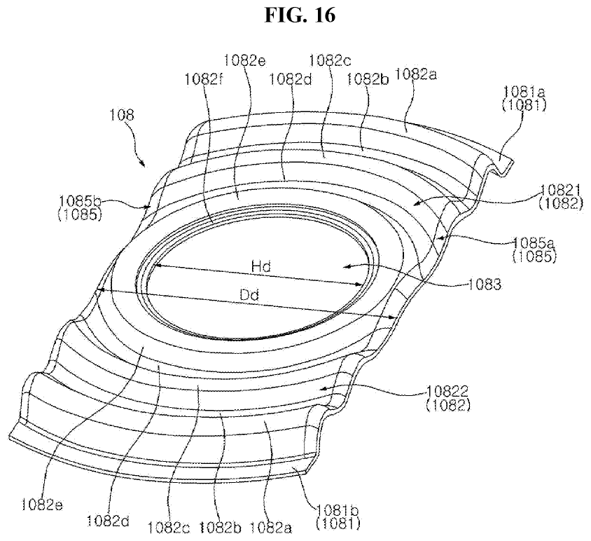

Referring to FIGS. 15 and 16, the damper 108 may include a damper frame 1081, a bobbin hole 1083, a vibrator 1082, and/or a side reinforcing part 1085. A plurality of damper frames 1081 may be provided. The damper frame 1081 may define both sides of the damper 108. For example, the damper frame 1071 may be an arc-shaped plate. A first damper frame 1081a may be disposed opposite a second damper frame 1081b with respect to the bobbin hole 1083.

The bobbin hole 1083 may be formed at the center of the first damper frame 1081a and the second damper frame 1081b. The bobbin hole 1083 may have a circular shape.

A plurality of vibrators 1082 may be provided. A first vibrator 10821 may be disposed between the first damper frame 1081a and the bobbin hole 1083. A second vibrator 10822 may be disposed between the second damper frame 1081b and the bobbin hole 1083.

The bobbin hole 1083 may be defined by the vibrator 1082. The vibrator 1082 may have a plurality of pleats or corrugations. For example, the vibrator 1082 may have a plurality of crests 1082a, 1082c, and 1082e and a plurality of roots 1082b, 1082d, and 1082f between the bobbin hole 1083 and the damper frame 1081.

The vibrator 1082 may include the plurality of crests 1082a, 1082c, and 1082e and the plurality of roots 1082b, 1082d, and 1082f. The plurality of crests 1082a, 1082c, and 1082e may include a first crest 1082a, a second crest 1082c, and/or a third crest 1082e. The plurality of roots 1082b, 1082d, and 1082f may include a first root 1082b, a second root 1082d, and/or a third root 1082f. Each of the roots 1082b, 1082d, and 1082f may be disposed between the plurality of crests 1082a, 1082c, and 1082e to form a wave.

The first crest 1082a may be connected to an inner diameter of the damper frame 1081. The first root 1082b may be connected to an inner diameter of the first crest 1082a. The second crest 1082c may be connected to an inner diameter of the first root 1082b. The second root 1082d may be connected to an inner diameter of the second crest 1082c. The third crest 1082e may be connected to an inner diameter of the second root 1082d. The third root 1082f may be connected to an inner diameter of the third crest 1082e. An inner diameter of the third root 1082f may define the bobbin hole 1083.

The damper 108, including the bobbin hole 1083, the vibrator 1082, and/or the damper frame 1081, may be in the form of a generally ring-shaped circular plate with both sides being partially cut off. The damper 108 may include a side reinforcing part 1085 defining a cutting edge of the damper frame 1081 and/or the vibrator 1082. For example, the side reinforcing part 1085 may form a wave in a linear direction. The damper 108 may move by vibrating the bobbin hole 1083 in a thickness direction of the damper 108 based on the damper frame 1081. The side reinforcing part 1085 may prevent rolling of the bobbin 105 (see FIG. 21) and may induce stable vibration of the bobbin 105 (see FIG. 21) and/or the damper 108.

A diameter Hd of the bobbin hole 1083 may be smaller than a distance Dd between side reinforcing parts 1085a and 1085b of the damper 108. In this case, the diameter Hd of the bobbin hole 1083 may be close to the distance Dd between the side reinforcing parts 1085a and 1085b of the damper 108. That is, this means that the distance Dd between the side reinforcing parts 1085a and 1085b of the damper 108 may be minimized, and the diameter of the bobbin 105 (see FIG. 12) may be maximized. A first difference between the distance Dd and the diameter Hd illustrated in FIG. 16 may be greater than a second difference between the distance Dd and the diameter Hd illustrated in FIG. 13.

As the bobbin 105 (see FIG. 21) inserted into the bobbin hole 1083 is formed in a circular shape, the intensity of sound pressure generated by the bobbin 105 and the diaphragm 107 may increase. At the same time, the width of the damper 108 is reduced, thereby allowing the speaker unit 100U (see FIG. 9) to become slimmer.

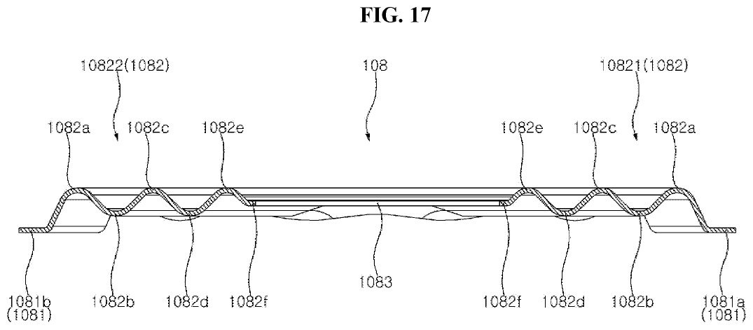

Referring to FIG. 17, the vibrator 1082 may have amplitudes between the crests 1082a, 1082c, and 1082e and the roots 1082b, 1082d, and 1082f. For example, the vibrator 1082 may have constant amplitudes between the crests 1082a, 1082c, and 1082e and the roots 1082b, 1082d, and 1082f of the vibrator 1082. In another example, the vibrator 1082 may have variable amplitudes between the crests 1082a, 1082c, and 1082e and the roots 1082b, 1082d, and 1082f of the vibrator 1082.

An amplitude between the first crest 1082a and the first root 1082b may be greater than an amplitude of the first root 1082b and the second crest 1082c. An amplitude between the first root 1082b and the second crest 1082c may be greater than an amplitude between the second crest 1082c and the second root 1082d. An amplitude between the second crest 1082c and the second root 1082d may be greater than an amplitude between the second root 1082d and the third crest 1082e. An amplitude between the second root 1082d and the third crest 1082e may be greater than an amplitude between the third crest 1082e and the third root 1082f. Accordingly, a vibration amplitude(or a vibration range or a range of motion) of the bobbin hole 1083 may be tuned in the width direction of the damper 108.

An amplitude between the first crest 1082a and the first root 1082b may be smaller than an amplitude of the first root 1082b and the second crest 1082c. An amplitude between the first root 1082b and the second crest 1082c may be smaller than an amplitude between the second crest 1082c and the second root 1082d. An amplitude between the second crest 1082c and the second root 1082d may be smaller than an amplitude between the second root 1082d and the third crest 1082e. An amplitude between the second root 1082d and the third crest 1082e may be smaller than an amplitude between the third crest 1082e and the third root 1082f. Accordingly, a vibration amplitude(or a vibration range or a range of motion) of the bobbin hole 1083 may be tuned in the width direction of the damper 108.

An amplitude between the first crest 1082a and the first root 1082b may be equal to an amplitude of the first root 1082b and the second crest 1082c. An amplitude between the first root 1082b and the second crest 1082c may be equal to an amplitude between the second crest 1082c and the second root 1082d. An amplitude between the second crest 1082c and the second root 1082d may be equal to an amplitude between the second root 1082d and the third crest 1082e. An amplitude between the second root 1082d and the third crest 1082e may be equal to an amplitude between the third crest 1082e and the third root 1082f. Accordingly, a vibration amplitude(or a vibration range or a range of motion) of the bobbin hole 1083 may be maintained constant in the width direction of the damper 108.

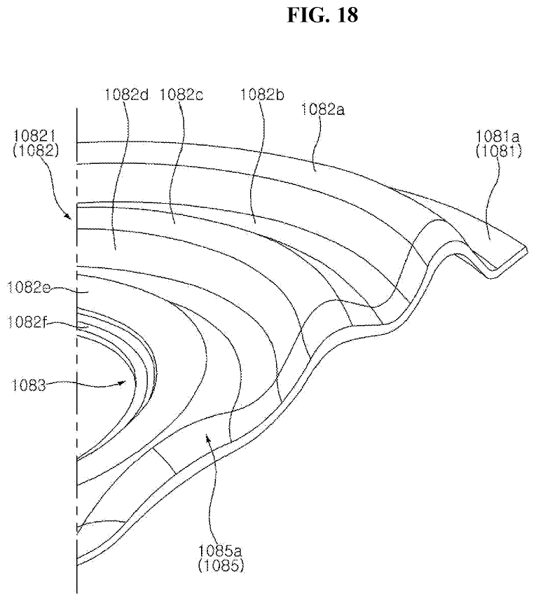

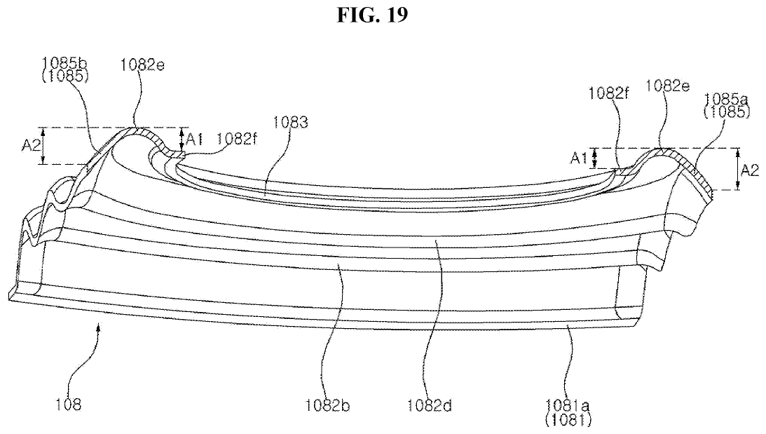

Referring to FIGS. 18 and 19, the side reinforcing part 1085 may include a first side reinforcing part 1085a and a second side reinforcing part 1085b. The side reinforcing part 1085 may be disposed opposite the bobbin hole 1083 with respect to the vibrator 1082 (see FIG. 18). The side reinforcing part 1085 may define the edge of the lateral side of the damper 108.

The side reinforcing part 1085 may form a slope descending from the third crest 1082e. An amplitude A2 from the third crest 1082e to the edge of the side reinforcing part 1085 may be greater than an amplitude A1 from the third crest 1082e to the third root 1082f. For example, the amplitude A1 between the third crest 1082e and the third root 1082f may be 1.5 mm to 2.5 mm, and the amplitude A2 from the third crest 1082e to the edge of the side reinforcing part 1085 may be twice or more the amplitude A1 between the third crest 1082e and the third root 1082f.

Accordingly, the side reinforcing part 1085 may maintain the rigidity of the lateral side or edge of the damper 108, ensuring a vibration amplitude of the damper 108.

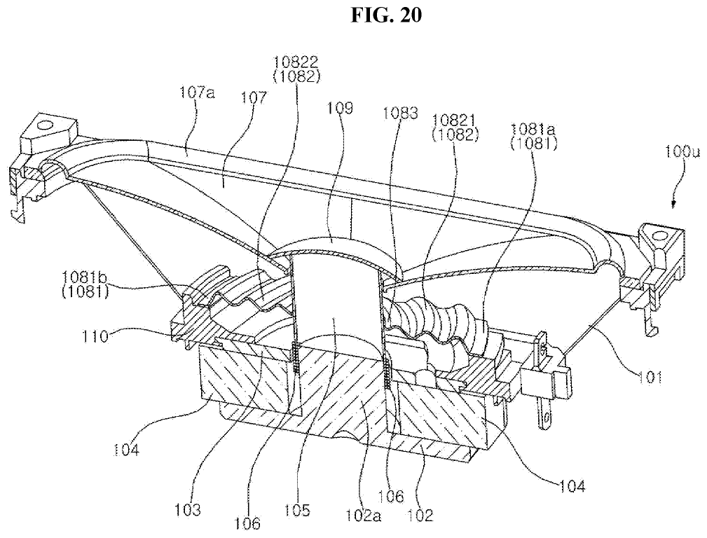

Referring to FIGS. 20 and 21, the pole piece 102a may protrude from a central portion of the first plate 102 may have a hollow cylindrical shape or a solid cylindrical shape. The pole piece 102a may have a cylindrical shape and a circular cross-section. A second plate 103 may be spaced apart from the first plate 102 and may have a circular plate shape or a ring shape. A portion of the pole piece 102a may pass through the second plate 103, and an air gap may be formed between the second plate 103 and the pole piece 102a.

The magnet 104 may be disposed between the first plate 102 and the second plate 103 and may have a ring shape or donut shape. A portion of the pole piece 102a may pass through the magnet 104. The bobbin 105 may be disposed in an air gap between the pole piece 102a and the second plate 103 and an air gap between the pole piece 102a and the magnet 104, and may have a hollow cylindrical shape that extends in a longitudinal direction of the pole piece 102a. The bobbin 105 may have a ring-shaped or donut-shaped cross section.

The coil 106 may be formed on or wound around an outer circumferential surface of the bobbin 105 and may be referred to as a voice coil 106.

The damper 108 may have elasticity. The damper 108 may be disposed between the bobbin 105 and the speaker frame 101. The damper 108 may support the bobbin 105. The damper frame 1081 may be fixed to the inside of the speaker frame 101. The speaker frame 101 may include a damper mount 110. The damper mount 110 may be coupled to the second plate 103. The damper mount 110 may be coupled to the speaker frame 101. The damper mount 110 may be located around the bobbin 105. The damper 108 may be fixed to the damper mount 110. The damper frame 1081 of the damper 108 may be fixed on the damper mount 110.

For example, the bobbin 105 may be inserted into the bobbin hole 1083 of the damper 108 and supported by the vibrator 1082. In another example, the bobbin 105 may be inserted or press-fit into the bobbin hole 1083 of the damper 108. In another example, the bobbin hole 1083 may be bonded to an outer surface of the bobbin 105 to be fixed thereto. Accordingly, the damper 108 may suppress rolling of the bobbin 105.

One side of the diaphragm 107 may be coupled or attached to the bobbin 105, and an opposite side of the diaphragm 107 may be supported by an elastic edge 107a. The diaphragm 107 may generate sound by vibrating in the longitudinal direction of the pole piece 102a.

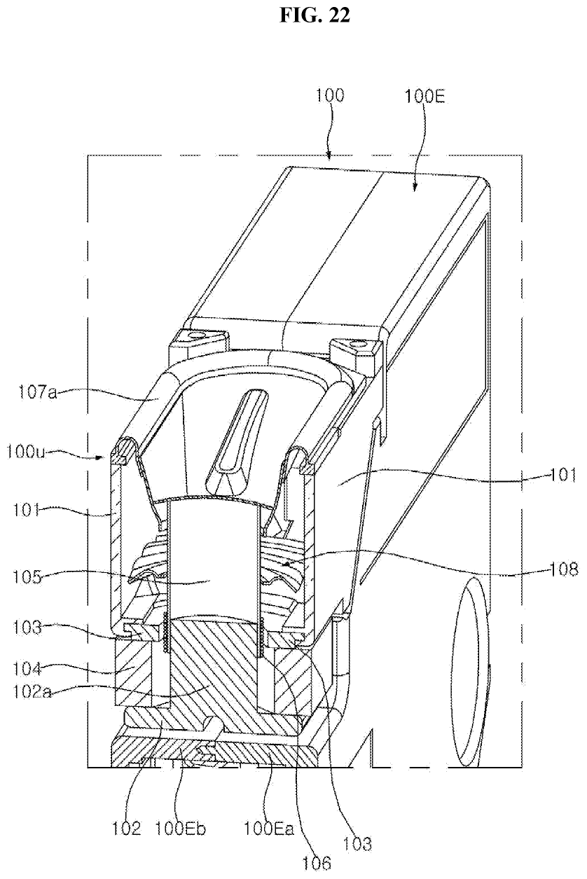

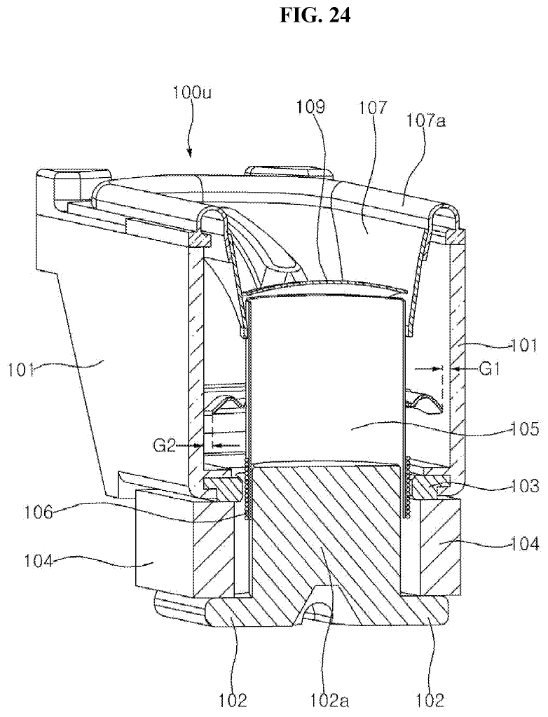

Referring to FIGS. 22 and 24, the damper 108 may reciprocate or vibrate with the bobbin 105. The damper 108 may be disposed between the bobbin 105 and the speaker frame 101. The damper 108 may support the bobbin 105.

For example, the bobbin 105 may be inserted into the bobbin hole 1083 of the damper 108 and supported by the vibrator 1082. In another example, the bobbin 105 may be inserted or press-fit into the bobbin hole 1083 of the damper 108. In another example, the bobbin hole 1083 may be bonded to an outer surface of the bobbin 105 to be fixed thereto. Accordingly, the damper 108 may suppress rolling of the bobbin 105.

The side reinforcing part 1085 of the damper 108 may be spaced apart from an inner surface of the speaker frame 101. A first gap G1 may be formed between the first side reinforcing part 1085a and the inner surface of the speaker frame 101. A second gap G2 may be formed between the second side reinforcing part 1085b and the inner surface of the speaker frame 101. When the damper 108 vibrates, the edge of the side reinforcing part 1085 of the damper 108 may vibrate at the free end. In this case, the side reinforcing part 1085 is provided such that the damper 108 may suppress rolling of the bobbin 105 without reducing the amplitude of a vibrating system.

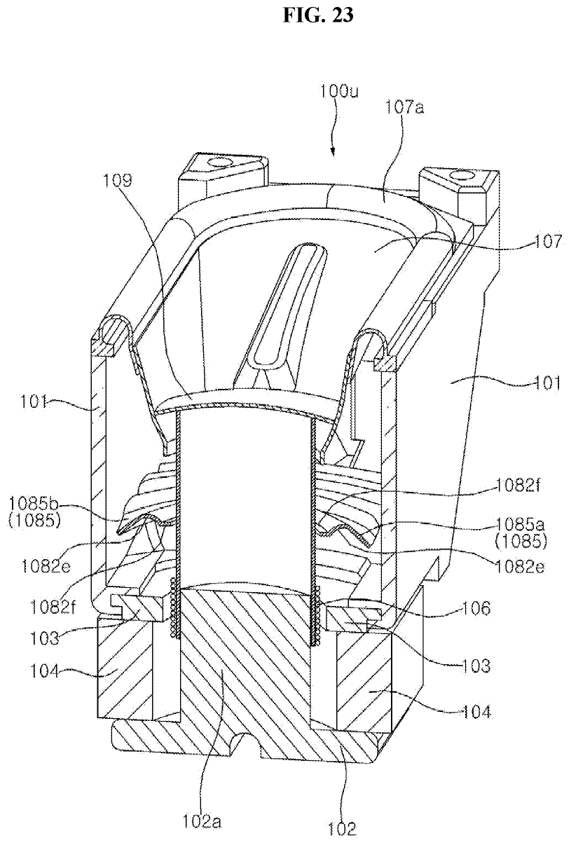

Referring to FIGS. 1 to 24, a display device includes: a display panel; a frame to which the display panel is coupled; and a speaker assembly coupled to the frame, wherein the speaker assembly includes: a speaker unit configured to provide sound; and an enclosure to which the speaker unit is coupled, wherein the speaker unit includes: a speaker frame defining a space; a diaphragm blocking one side of the space and connected to the speaker frame; a bobbin disposed in the space of the speaker frame and connected to the diaphragm to vibrate the diaphragm; and a damper having one side fixed to the speaker frame and an opposite side supporting the bobbin, wherein the damper includes: a first damper frame fixed to one side of the speaker frame; a second damper frame disposed opposite the first damper frame with respect to the bobbin and fixed to an opposite side of the speaker frame; a bobbin hole into which the bobbin is inserted; and a vibrator connecting the bobbin hole and the damper frame and having a wave shape, wherein the vibrator has an edge which is cut from the first damper frame toward the second damper frame such that a wave-shaped cross section of the vibrator is exposed.

The edge may include: a first edge extending from the first damper frame to the second damper frame; and a second edge disposed opposite the first edge with respect to the bobbin hole and extending from the first damper frame to the second damper frame.

The damper may further include a side reinforcing part defining the edge of the vibrator, wherein the side reinforcing part may be bent in a thickness direction of the vibrator.

The damper may further include: a first side reinforcing part defining the first edge of the vibrator; and a second side reinforcing part defining the second edge of the vibrator, wherein the first side reinforcing part may be bent opposite to the diaphragm in a thickness direction of the vibrator, and the second side reinforcing part may be bent opposite to the diaphragm in the thickness direction of the vibrator.

The bobbin hole may have a circular shape.

The edge may include: a first edge extending from the first damper frame to the second damper frame; and a second edge disposed opposite the first edge with respect to the bobbin hole and extending from the first damper frame to the second damper frame, wherein the damper may further include: a first side reinforcing part defining the first edge of the vibrator; and a second side reinforcing part defining the second edge of the vibrator, wherein a distance between the first edge of the vibrator and the second edge of the vibrator may be greater than a diameter of the bobbin hole.

A distance between the first damper frame and the second damper frame may be greater than the distance between the first edge of the vibrator and the second edge of the vibrator.

The bobbin hole may have a circular shape, wherein the vibrator may include a plurality of crests and a plurality of roots that are formed around the bobbin hole toward the first damper frame or the second damper frame.

Each of the plurality of crests and each of the plurality of roots may have different amplitudes.

Each of the plurality of crests and each of the plurality of roots may have constant amplitudes.

The vibrator of the damper may include: a crest formed between the bobbin hole and the side reinforcing part; and a root formed between the crest and the bobbin hole, wherein a first amplitude between the crest and the root may be smaller than an amplitude between the crest and the edge of the side reinforcing part.

The second amplitude may be twice or more the first amplitude.

The side reinforcing part of the damper may be spaced apart from the speaker frame.

The speaker unit may include a damper mount disposed around the bobbin and coupled to the speaker frame, wherein the first damper frame may be fixed to one side of the damper mount, and the second damper frame may be fixed to an opposite side of the damper mount.

The bobbin hole may be fixed to the bobbin.

A speaker assembly includes: a speaker unit configured to provide sound; and an enclosure to which the speaker unit is coupled, wherein the speaker unit includes: a speaker frame defining a space; a diaphragm blocking one side of the space and connected to the speaker frame; a bobbin disposed in the space of the speaker frame and connected to the diaphragm to vibrate the diaphragm; and a damper having one side fixed to the speaker frame and an opposite side supporting the bobbin, wherein the damper includes: a first damper frame fixed to one side of the speaker frame; a second damper frame disposed opposite the first damper frame with respect to the bobbin and fixed to an opposite side of the speaker frame; a bobbin hole into which the bobbin is inserted; and a vibrator connecting the bobbin hole and the damper frame and having a wave shape, wherein the vibrator has an edge which is cut from the first damper frame toward the second damper frame such that a wave-shaped cross section of the vibrator is exposed.

The edge may include: a first edge extending from the first damper frame to the second damper frame; and a second edge disposed opposite the first edge with respect the bobbin hole and extending from the first damper frame to the second damper frame, wherein the damper may further include: a first side reinforcing part defining the first edge of the vibrator; and a second side reinforcing part defining the second edge of the vibrator, wherein a distance between the first edge of the vibrator and the second edge of the vibrator may be greater than a diameter of the bobbin hole.

A distance between the first damper frame and the second damper frame may be greater than the distance between the first edge of the vibrator and the second edge of the vibrator.

The bobbin hole may have a circular shape, wherein the vibrator may include a plurality of crests and a plurality of roots that are formed around the bobbin hole toward the first damper frame and the second damper frame.

The damper may further include a side reinforcing part defining the edge of the vibrator, wherein the side reinforcing part may be bent in a thickness direction of the vibrator, wherein the vibrator of the damper may include: a crest formed between the bobbin hole and the side reinforcing part; and a root formed between the crest and the bobbin hole, wherein a first amplitude between the crest and the root may be smaller than an amplitude between the crest and the edge of the side reinforcing part.

Certain embodiments or other embodiments of the invention described above are not mutually exclusive or distinct from each other. Any or all elements of the embodiments of the invention described above may be combined or combined with each other in configuration or function.

For example, a configuration “A” described in one embodiment of the invention and the drawings and a configuration “B” described in another embodiment of the invention and the drawings may be combined with each other. Namely, although the combination between the configurations is not directly described, the combination is possible except in the case where it is described that the combination is impossible.

The foregoing embodiments are merely examples and are not to be considered as limiting the present disclosure. The scope of the present disclosure should be determined by rational interpretation of the appended claims, and all modifications within the equivalents of the disclosure are intended to be included within the scope of the present disclosure.

What is claimed is:

1. A display device comprising:
a display panel;
a frame to which the display panel is coupled; and
a speaker assembly coupled to the frame,
wherein the speaker assembly comprises:
a speaker unit configured to provide sound; and
an enclosure to which the speaker unit is coupled,
wherein the speaker unit comprises:
a speaker frame defining a space;
a diaphragm blocking one side of the space and connected to the speaker frame;
a bobbin disposed in the space of the speaker frame and connected to the diaphragm to vibrate the diaphragm; and
a damper having one side fixed to the speaker frame and an opposite side supporting the bobbin,
wherein the damper comprises:
a first damper frame fixed to one side of the speaker frame;
a second damper frame disposed opposite the first damper frame with respect to the bobbin and fixed to an opposite side of the speaker frame;
a bobbin hole into which the bobbin is inserted; and
a vibrator connecting the bobbin hole and the damper frame and having a wave shape,
wherein the vibrator has an edge which is cut from the first damper frame toward the second damper frame such that a wave-shaped cross section of the vibrator is exposed.

2. The display device of claim 1, wherein the edge comprises:
a first edge extending from the first damper frame to the second damper frame; and
a second edge disposed opposite the first edge with respect to the bobbin hole and extending from the first damper frame to the second damper frame.

3. The display device of claim 1, wherein the damper further comprises a side reinforcing part defining the edge of the vibrator,
wherein the side reinforcing part is bent in a thickness direction of the vibrator.

4. The display device of claim 2, wherein the damper further comprises:
a first side reinforcing part defining the first edge of the vibrator; and
a second side reinforcing part defining the second edge of the vibrator,
wherein the first side reinforcing part is bent opposite to the diaphragm in a thickness direction of the vibrator, and the second side reinforcing part is bent opposite to the diaphragm in the thickness direction of the vibrator.

5. The display device of claim 1, wherein the bobbin hole has a circular shape.

6. The display device of claim 1, wherein the edge comprises:
a first edge extending from the first damper frame to the second damper frame; and
a second edge disposed opposite the first edge with respect to the bobbin hole and extending from the first damper frame to the second damper frame,
wherein the damper further comprises:
a first side reinforcing part defining the first edge of the vibrator; and
a second side reinforcing part defining the second edge of the vibrator,
wherein a distance between the first edge of the vibrator and the second edge of the vibrator is greater than a diameter of the bobbin hole.

7. The display device of claim 6, wherein a distance between the first damper frame and the second damper frame is greater than the distance between the first edge of the vibrator and the second edge of the vibrator.

8. The display device of claim 1, wherein the bobbin hole has a circular shape,
wherein the vibrator comprises a plurality of crests and a plurality of roots that are formed around the bobbin hole toward the first damper frame or the second damper frame.

9. The display device of claim 8, wherein each of the plurality of crests and each of the plurality of roots have different amplitudes.

10. The display device of claim 8, wherein each of the plurality of crests and each of the plurality of roots have constant amplitudes.

11. The display device of claim 3, wherein the vibrator of the damper comprises:
a crest formed between the bobbin hole and the side reinforcing part; and
a root formed between the crest and the bobbin hole,
wherein a first amplitude between the crest and the root is smaller than an amplitude between the crest and the edge of the side reinforcing part.

12. The display device of claim 11, wherein the second amplitude is twice or more the first amplitude.

13. The display device of claim 3, wherein the side reinforcing part of the damper is spaced apart from the speaker frame.

14. The display device of claim 1, wherein the speaker unit comprises a damper mount disposed around the bobbin and coupled to the speaker frame,
wherein the first damper frame is fixed to one side of the damper mount, and the second damper frame may be fixed to an opposite side of the damper mount.

15. The display device of claim 14, wherein the bobbin hole is fixed to the bobbin.

16. A speaker assembly comprises:
a speaker unit configured to provide sound; and
an enclosure to which the speaker unit is coupled,
wherein the speaker unit comprises:
a speaker frame defining a space;
a diaphragm blocking one side of the space and connected to the speaker frame;
a bobbin disposed in the space of the speaker frame and connected to the diaphragm to vibrate the diaphragm; and
a damper having one side fixed to the speaker frame and an opposite side supporting the bobbin,
wherein the damper comprises:
a first damper frame fixed to one side of the speaker frame;
a second damper frame disposed opposite the first damper frame with respect to the bobbin and fixed to an opposite side of the speaker frame;
a bobbin hole into which the bobbin is inserted; and
a vibrator connecting the bobbin hole and the damper frame and having a wave shape,
wherein the vibrator has an edge which is cut from the first damper frame toward the second damper frame such that a wave-shaped cross section of the vibrator is exposed.

17. The speaker assembly of claim 16, wherein the edge comprises:
a first edge extending from the first damper frame to the second damper frame; and
a second edge disposed opposite the first edge with respect the bobbin hole and extending from the first damper frame to the second damper frame,
wherein the damper further comprises:
a first side reinforcing part defining the first edge of the vibrator; and
a second side reinforcing part defining the second edge of the vibrator,
wherein a distance between the first edge of the vibrator and the second edge of the vibrator is greater than a diameter of the bobbin hole.

18. The speaker assembly of claim 17, wherein a distance between the first damper frame and the second damper frame is greater than the distance between the first edge of the vibrator and the second edge of the vibrator.

19. The speaker assembly of claim 16, wherein the bobbin hole has a circular shape,
wherein the vibrator comprises a plurality of crests and a plurality of roots that are formed around the bobbin hole toward the first damper frame and the second damper frame.

20. The speaker assembly of claim 16, wherein the damper further comprises a side reinforcing part defining the edge of the vibrator,
wherein the side reinforcing part is bent in a thickness direction of the vibrator,
wherein the vibrator of the damper comprises:
a crest formed between the bobbin hole and the side reinforcing part; and
a root formed between the crest and the bobbin hole,
wherein a first amplitude between the crest and the root is smaller than an amplitude between the crest and the edge of the side reinforcing part.
